(19) United States
(12) Patent Application Publication
(10) Pub. No.: US 2024/0160994 A1
(43) Pub. Date: May 16, 2024

(54) DYNAMIC CHECKPOINT FOR SIMULATION

(71) Applicant: Dell Products L.P., Round Rock, TX (US)

(72) Inventors: Victor Fong, Medford, MA (US); Brendan Burns Healy, Haddonfield, NJ (US); Benjamin E. Santaus, Somerville, MA (US)

(21) Appl. No.: 18/345,364

(22) Filed: Jun. 30, 2023

Related U.S. Application Data
(60) Provisional application No. 63/383,344, filed on Nov. 11, 2022.

(51) Int. Cl. G06N 10/80

(52) U.S. Cl. CPC G06N 10/80

(57) ABSTRACT

One example method includes simulating execution of a quantum circuit on a classical computing infrastructure, after one or more times that a gate of the quantum circuit is executed as part of the simulating, creating, after execution of that gate, a hash of a state vector that captures a state of the execution of the quantum circuit, storing the hash, and respective associated data structure, in storage, then as part of a simulated execution process, calculating a hash of each gate across the new quantum circuit, looking up, in the storage, a hash of a state vector associated with execution of one of the gates of the new quantum circuit, and restoring, from storage, the latest hash of the state vector associated with the one gate of the new quantum circuit.

### FIELD OF THE INVENTION

Some embodiments of the present invention generally relate to quantum computing. More particularly, at least some embodiments of the invention relate to systems, hardware, software, computer-readable media, and methods, for a mechanism to checkpoint states in quantum computing in an automated or programmatic manner, to reduce the time it takes to simulate quantum circuits with storage.

### BACKGROUND

Due to the expense, and lack of availability of, quantum computing resources, the execution of quantum circuits may be simulated, such as on classical computing hardware, rather than being executed on quantum hardware. However, simulating quantum circuit execution has drawbacks. For example, simulating circuit execution is a resource- and time-consuming process. Some circuit simulations would require days or weeks to complete. Furthermore, some end-to-end algorithms would require execution of similar circuits over many iterations. This issue is further complicated by conditional and loop capabilities of QPUs (quantum processing units) which take measurements of one or more qubits mid-circuit and, based on those measurements, introduce dynamic circuit gate execution.

In more detail, some circuit simulations take days, or weeks to execute. If a simulation crashes mid-execution, the simulation would need to restart. Further, even across multiple circuits, there may be similar circuit executions. This is especially common for iterative execution for one circuit design with different parameters. Moreover, without built-in support into simulation engines, execution platforms do not know when to checkpoint mid-execution. Finally, without a look-up mechanism, simulation engines do not know when a particular checkpoint can be re-used for another simulation.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying Figures.

FIG. 1 discloses an architecture according to one example embodiment.

FIG. 2 discloses a method according to one example embodiment.

FIG. 3 discloses a computing entity configured and operable to perform any of the disclosed methods, processes, and operations.

### DETAILED DESCRIPTION OF SOME EXAMPLE EMBODIMENTS

Some embodiments of the present invention generally relate to quantum computing. More particularly, at least some embodiments of the invention relate to systems, hardware, software, computer-readable media, and methods, for a mechanism to checkpoint states in quantum computing in an automated or programmatic manner, to reduce the time it takes to simulate quantum circuits with storage.

In general, an embodiment of the invention may comprise a mechanism that operates to checkpoint, at various points in time, the state of a quantum circuit during a simulated execution of that quantum circuit. This checkpointing may be performed in an automated or programmatic manner, for example. The information obtained from the checkpointing operations may be used to reduce the time that it takes to simulate the execution of other quantum circuits. As well, this information may enable a reduction in data storage requirements associated with simulations of the execution of those other quantum circuits.

In more detail, one embodiment comprises a method that pauses, mid-execution, a quantum circuit execution simulation, examples of which may also be referred to herein simply as a ‘simulation,’ and then checks the state of the circuit, where the state may be expressed in the form of a vector that represents the quantum state of all the qubit combinations of the circuit. This state information may then be written to memory/storage. Thus, if that exact state is needed again, such as for another simulation, the state can be read out from storage, rather than being recomputed. In this way, an embodiment may reduce overall computation time for a simulation, and may also reduce, relative to conventional checkpointing approaches, storage requirements associated with a simulation. In an embodiment, there is no use of an actual quantum computer, and a method according to one embodiment is performed entirely using classical computing hardware and systems.

Further information concerning one or more example embodiments of the invention is disclosed in Appendix A hereto. Appendix A forms a part of this disclosure and is incorporated herein in its entirety by this reference.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that an amount of storage space consumed by a simulation is reduced relative to conventional approaches to static checkpointing that do not employ the disclosed methods. As another example, an embodiment may enable quantum circuit simulations to proceed relatively more quickly as compared with approaches that do not employ the disclosed methods. Various other advantages of one or more embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Introduction

Simulating quantum circuit (QC) execution is a resource, and time, consuming process. Some circuit simulations may require days or weeks to complete. Furthermore, some end-to-end algorithms may require execution of similar circuits over many iterations. This issue is further complicated by conditional and loop capabilities of QPUs (quantum processing units), which take measurements of one or more qubits mid-circuit and based on the measurement, introduce dynamic circuit gate execution. Thus, one or more embodiments of the invention are directed to a mechanism that operates to checkpoint states in quantum computing simulations in an automated or programmatic manner, to reduce the time it takes to simulate quantum circuits.

### B. General Aspects of Some Example Embodiments

An embodiment may help to reduce, or eliminate, crashes that may occur during circuit executions that may take days or weeks to execute. If a crash does occur during a circuit execution, an embodiment may help to minimize the amount of time needed to restart the execution. Particularly, an embodiment may enable a simulated circuit execution to be restored quickly without the need to completely re-calculate each of the simulation states from the beginning of the circuit execution.

An embodiment may address circumstances in which, even across multiple circuits, there may be similar circuit executions. This may be common for iterative execution for one circuit design with different parameters.

An embodiment may operate to intelligently checkpoint, possibly mid-execution of a circuit simulation, states in quantum computing in an automated or programmatic manner, to reduce the time it takes to simulate quantum circuits with storage. In an embodiment, this functionality may be built-in to a simulation engine of an execution platform.

An embodiment may provide a lookup mechanism that may enable a simulation engine to know when to a checkpoint can be re-used.

### C. Aspects of an Example Architecture and Related Operations

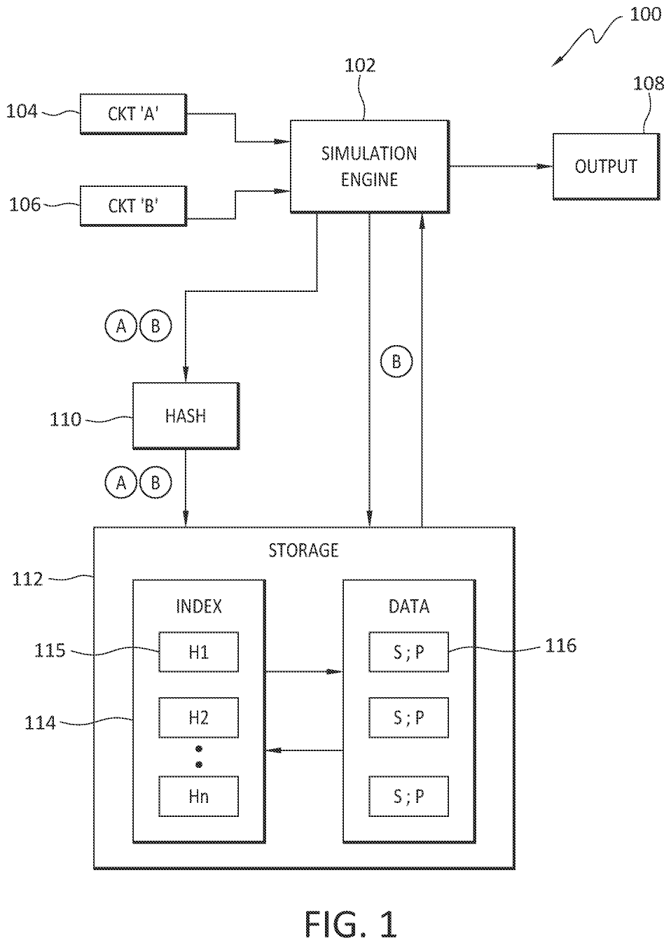

With attention now to FIG. 1, an example architecture according to one embodiment is denoted at 100. The architecture 100 may include one or more simulation engines 102 which may or may not be an element of an overall platform embracing the various entities disclosed in FIG. 1. The simulation engine 102 may run on a classical computing infrastructure and, among other things, may operate to simulate the execution of quantum circuits, such as the circuits 104 and 106. The operations of the simulation engine 102 may produce various outputs 108, one example of which is a solution to a problem represented by, or otherwise associated with, one of the circuits 102 and/or 104.

In an embodiment, part, or all, of the simulation of the execution of circuit 104 (denoted as CKT ‘A’) may precede simulation of the execution of circuit 106 (denoted as CKT ‘B’). While, in an embodiment, the circuits 104 and 106 may be different in terms of their overall configuration and execution, the circuit 104 may nonetheless comprise, for example, an element that has the same state as an element of the circuit 106. In this sense, there may be some commonality between/among circuits submitted to the simulation engine 102.

As the simulation of the execution of circuit 104 by the simulation engine 102 is ongoing, the simulation engine 102 may perform, or cause the performance of, a hashing of a portion of the circuit 104. Note that as used herein, a ‘hash’ or ‘hash function’ may use a bit string, which may pertain to a classical computing element, as an input, and produce a quantum state as a corresponding output. Thus, each hash may correspond to, or define, a particular state of the circuit 104, or a portion of the circuit 104. In an embodiment, and discussed in more detail below, a hash may be taken after each gate execution.

Multiple hashes of respective portions of the circuit 104, or any circuit, may be performed at various times while the simulation of the execution of the circuit 104 is ongoing. Aspects of a circuit or circuit portion that may be hashed include, but are not limited to, any one or more of qubits, gates, parameters, and previous hashes of that portion of the circuit 104. The hashing may be performed by a hash module 110 with which the simulation engine 102 may be configured to communicate. In an embodiment, the hash module 110 may be integrated directly into the simulation engine 102, but that is not required.

With continued reference to the example of FIG. 1, hashes generated by the hash module 110, or other entity, may be retrievably stored at a storage site or storage device 112. In an embodiment, the storage 112 may include an index 114 that identifies all the hashes 115 that are stored. As shown, each of the hashes 115 listed in the index 114 may correspond to a respective data structure 116. Each of the data structures 116 may comprise, for example, a copy of the simulation state associated with a hash 115, along with a pointer to a previous hash 115, that is, a hash 115 created earlier in time than the hash 115 with which the particular data structure 116 is associated.

In the example of FIG. 1, the hashing and storage operations may be performed with regard to both the circuits 104 and 106. However, as the simulation of circuit 106 is being performed, hashes of the gates in the circuit 106 may be looked up, by the simulation engine 102, in the index 114. The most recent hash 115 on the circuit 106 that is located in the index 114 may then be restored by the simulation engine 102. In this way, state information from a previous simulation, of circuit 104 in this example, may be used in the simulation of circuit 106, thereby improving the efficiency of the simulation for circuit 106.

As also disclosed elsewhere herein, the stored state information may also be used in the event that a simulation operation fails for some reason. Briefly, the most recent stored state information pertaining to the circuit being simulated may be restored, and the simulation of the circuit then continued from the state to which the restored state information pertains.

### D. Detailed Description of Aspects of an Embodiment

### D.1 Hash and State Vector

In general, the state of a quantum circuit may be described using a multi-dimensional vector. One method of simulating, on classical hardware, the execution of a quantum circuit is thus referred to as state vector simulation. In this approach, execution of the quantum circuit may be simulated by multiplying the state vector by respective matrices that correspond to the gate sequence of the quantum circuit.

In an embodiment, a hash of a state vector may serve as a unique identifier of the circuit up to a particular point in the execution of that circuit. While the state vector may, depending upon the size and nature of the circuit, be quite large in terms of the storage space it can be expected to consume, the hash of the state vector is comparatively small. Thus, an embodiment may conserve storage space by storing only hashes of state vectors, rather than storing the state vectors themselves.

In more detail, in the circuit whose execution is being simulated, the gates are applied in sequence. After each gate is applied, a new hash is generated of the state of the circuit at that point, as that state is expressed by the state vector, and the hashes stored. In this way, the state of the circuit is captured after each gate is applied. In the event that, for example, the circuit simulation were to crash for some reason, a user may wish to restore the full state vector at some point in the circuit prior to when the crash occurred. In an embodiment, this restoration may be implemented using the hashes that were previously created.

In particular, an embodiment may calculate hashes of the state vectors, beginning with the last state vector before the crash. This process may be performed relatively quickly since hashing the state vector may be easier, and faster, than going back and simulating the execution of the circuit. For each hash that is created, a check may be performed of an index, such as the index 114 of FIG. 1 for example, to determine if that hash corresponds to a state, that is, a hash of a state vector, that was previously saved in storage. This hash and check process may be performed beginning with the most recent state vector and working backwards in time toward the oldest state vector until a hash matches with a state vector found in storage. In this way, the state of the circuit may be restored to the most recent good state, and the simulation may be resumed as far along as possible in the execution of the circuit. Note that the process of checking the index may be performed relatively quickly, and when a stored state is located in storage, that state may be restored into memory, and simulation of the circuit resumed from that state.

### D.2 Operational Aspects of an Example Embodiment

With the foregoing discussion in view, in an embodiment, the state of a circuit, as may be expressed by a state vector, may be hashed. The state vector, and/or other information that may be hashed may include, but is not limited to qubits, gates, parameters of the circuit, and previous hashes. After each gate execution in the simulation, a new hash may be produced. Note that, in an embodiment, this hash may not include the actual states of quantum simulation.

In more detail, after gate execution, a platform, according to one embodiment, may make a copy of the simulation state, and the simulation state may be expressed in the form of a state vector. Various programming techniques, including callback hooks into simulation engines, may implement this functionality. In an embodiment, a gate execution or series of gates that do not impact all simulation states, but only a subset of simulation states, only the changed states may be copied. In certain transpilation methods, all multi qubit gates may, for example, be broken down into 1 and 2 qubit gates, which may increase the probability that a checkpoint mechanism will only need to capture a subset of states, thus saving both time and storage, at least relative to static checkpointing approaches.

Note that an embodiment may increase storage requirements, relative to volatile memory that might be employed to store the state information. However, this may be an acceptable consequence, since storage is significantly cheaper, and less restrictive, than volatile memory, when considered on a per-byte basis. As noted herein, an embodiment of the dynamic checkpointing mechanism may use less storage than a conventional static checkpointing mechanism.

In an embodiment, and as noted earlier in the discussion of FIG. 1, the copy of the simulation states may be associated with a hash, as well as with a pointer to a previous hash. These data structures may be persisted in storage with a hash index. Note that this example data structure design may be similar to a layered filesystem, such as one used for container images. Furthermore, multiple hashes may point to the same previous hash.

When trying to execute a new circuit simulation, an embodiment may provide that the hash of each gate across the circuit will be calculated. Each hash may then be looked up on the index. The latest hash in the circuit, found on the index, may then be restored.

When restoring a state, whether due to a simulation crash, or because a prior state that was previously stored is applicable to a current, ongoing, simulation for a different circuit, the data structures associated with the hash, as well as the data structures respectively associated with all the previous hashes, may be copied into memory in reverse order, that is beginning with the most recent. The first hash of the circuit, that is, one without a previous hash, may be copied first and changes may then be applied to state according to hash order, that is, in the reverse of the order in which the hashes were taken. After execution of an end-to-end algorithm, the data structures may be discarded, or stored for future use, depending on user preferences and storage availability.

In an embodiment, if a user does not want to enable checkpointing, that is, hashing a state vector for each gate, a custom gate, which may be referred to herein as a “checkpoint” gate or a “dummy” gate, may be added to the circuit. This checkpoint gate may be ignored for QPUs, but a simulation engine may invoke callbacks when executing this gate, to enable developers to programmatically control when checkpointing will be performed during a simulation. In an embodiment, the checkpointing and state restoration process may be further sped up through the use of persistent memory technologies, so that the changed states may be quickly persisted and loaded.

### E. Further Discussion

One or more embodiments of the invention may possess various useful features and aspects. Following is a non-exhaustive list of examples. It is noted that while some checkpointing and restoring mechanisms exist, they cannot be used to replay a quantum circuit gate to reduce time for execution. In conventional approaches, checkpoints typically include the actual process and execution register set to completely restore a running process. By way of contrast, an embodiment of the invention differs in that only the simulation state is captured, while the circuit execution is tracked with hashes. Moreover, conventional checkpointing methods must be called manually by the user. By automating a checkpointing process, an embodiment may intelligently deploy checkpointing where it will be most useful and will require the least storage and extra execution time.

Thus, an embodiment comprises a mechanism and data structure, which are employed so that a previously executed simulation can be restored quickly without the need to completely re-calculate each of the simulation states from the beginning of a circuit. In an embodiment, the checkpointing may be performed automatically by the system during execution, rather than having to be hardcoded into the circuit design.

An embodiment may be advantageous in that it may be able to replay a quantum circuit gate to reduce time for simulated execution of the quantum circuit. Further, an embodiment may avoid the need to perform a checkpoint that includes the actual process and execution register set to completely restore a running process. Instead, an embodiment may capture only the simulation state, and the state of circuit execution may be tracked with hashes of state vectors.

As another example, and embodiment may provide an automated checkpointing process which may produce better results than a checkpoint method which is manually called by a user. Particularly, by providing an automated checkpoint process, an embodiment may intelligently deploy checkpointing where it will be most useful and require the least storage and extra execution time.

In another example, an embodiment may implement, and use, a hashing mechanism and data structure, so that a previously executed quantum circuit simulation may be restored quickly without the need to completely re-calculate each of the simulation states from the beginning of the circuit.

Finally, an embodiment may provide for automatic checkpointing by the system during circuit execution, rather than needing to be hardcoded into the circuit design.

### F. Example Methods

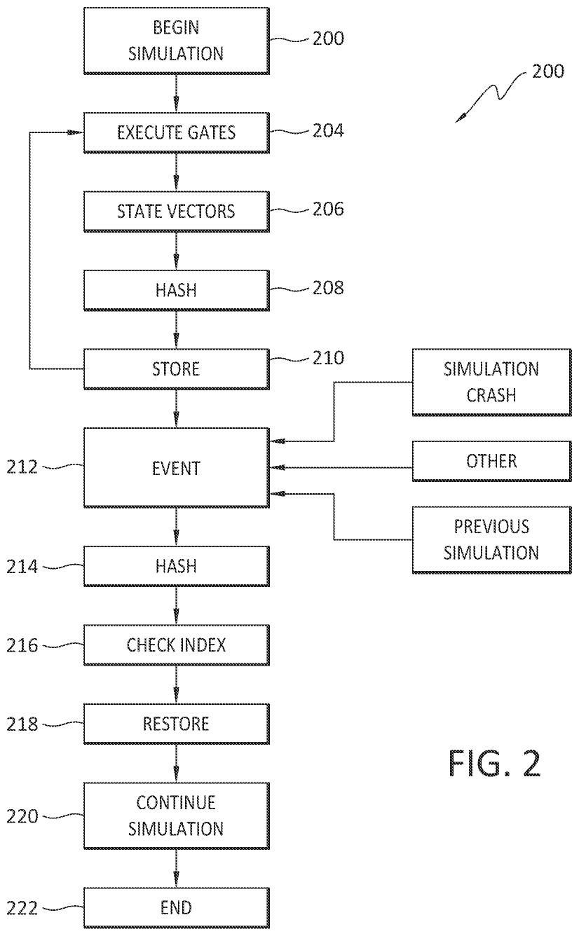

It is noted with respect to the disclosed methods, including the example method of FIG. 2, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

With attention now to FIG. 2, a method according to one example embodiment is denoted generally at 200. In an embodiment, the method 200 may performed in whole or in part by, and/or at the direction of, a simulation engine, examples of which are disclosed herein.

The method 200 may begin with the instantiation 202 of the simulation of the execution of a quantum circuit on a classical computing infrastructure. The simulation may comprise the execution 204 of gates of the quantum circuit. In an embodiment, a state vector that captures the state of the simulation may thus be defined 206 after the execution 204 of each gate, and/or at one or more specified points in the circuit. Note that the state information of the state vector may not, in an embodiment, be explicitly captured but may simply be implied by the execution of a gate, or gates.

The state vectors thus defined 206 may then be hashed 208. In an embodiment, a state vector may be hashed immediately following its creation or definition. The hashes, and respective associated data structures, may then be retrievably stored 210 in storage.

At some point after the gate(s) have started to be executed 204, a circumstance or event 212 may necessitate the retrieval of state information, such as one of more of the hashes of the state vectors that were stored 210 earlier. Such an event may comprise, for example, a crash of the simulation process, a need to check for states that were used in a prior simulation, or other event. Where a crash has occurred, respective hashes 214 may be taken of one or more of the vector states, beginning with the most recent just prior to the crash. For each of these hashes, an index may be checked 216 to determine if the state corresponding to the hash was stored. The hashing/checking may continue until a stored state is found that corresponds to one of the hashes 214, and that stored state may then be restored 218 to the simulation using information from the data structure that was stored in connection with that hash. At this point, the simulation may be resumed 220 and continue to run until another event occurs and/or until completion 222.

Embodiments are not limited solely to dealing with simulation crash situations. As noted elsewhere herein, an embodiment may restore 218 a stored state that was used in a prior simulation. In so doing, an embodiment may avoid the need to perform the execution of the gate(s) that resulted in that state, and thereby run the simulation relatively more quickly than if those gates had to be executed.

### G. Further Example Embodiments

Following are some further example embodiments of the invention. These are presented only by way of example and are not intended to limit the scope of the invention in any way.

Embodiment 1. A method, comprising: simulating execution of a quantum circuit on a classical computing infrastructure; after one or more times that a gate of the quantum circuit is executed as part of the simulating, creating, after execution of that gate, a hash of a state vector that captures a state of the execution of the quantum circuit; storing the hash, and respective associated data structure, in storage; as part of a simulated execution process, calculating a hash of each gate across the new quantum circuit; looking up, in the storage, a hash of a state vector associated with execution of one of the gates of the new quantum circuit; and restoring, from storage, the latest hash of the state vector associated with the one gate of the new quantum circuit.

Embodiment 2. The method as recited in any preceding embodiment, wherein the simulated execution process comprises a resumption of the simulating of the execution of the quantum circuit.

Embodiment 3. The method as recited in any preceding embodiment, wherein the simulated execution process comprises simulating execution of a new quantum circuit that is different from the quantum circuit but has one or more states in common with the quantum circuit.

Embodiment 4. The method as recited in any preceding embodiment, wherein the restoring is performed for multiple gates and, for each gate, respective hashes are restored in reverse order.

Embodiment 5. The method as recited in any preceding embodiment, wherein the creating and storing are performed automatically during the simulating.

Embodiment 6. The method as recited in any preceding embodiment, wherein restoring the latest hash obviates a need to re-execute the gate, and recalculate a state vector, to which that latest hash pertains.

Embodiment 7. The method as recited in any preceding embodiment, wherein the hashes of the state vectors are created each time a gate is executed.

Embodiment 8. The method as recited in any preceding embodiment, wherein a gate of the quantum circuit comprises a custom gate which, when executed, triggers hashing of a state vector associated with the custom gate.

Embodiment 9. The method as recited in any preceding embodiment, wherein hashes are created for fewer than all of the gates of the quantum circuit.

Embodiment 10. The method as recited in any preceding embodiment, wherein when a gate execution does not affect the state, that state is not hashed.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed. In general, embodiments may comprise classical, and/or quantum, hardware and/or software. Quantum hardware may include, for example, physical qubits and QPUs. Quantum circuits may comprise, for example, real and/or virtual qubits.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

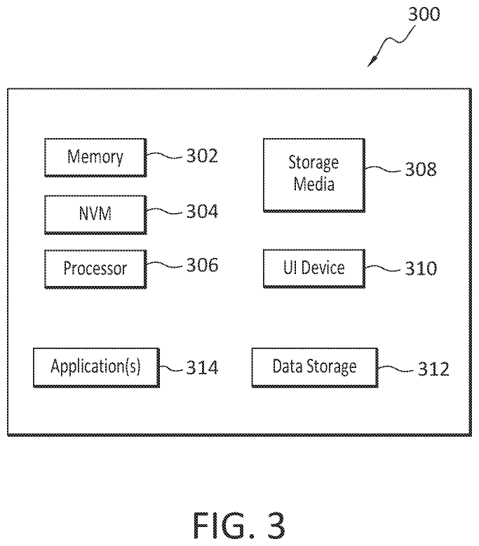

With reference briefly now to FIG. 3, any one or more of the entities disclosed, or implied, by FIGS. 1-2, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
simulating execution of a quantum circuit on a classical computing infrastructure;
after one or more times that a gate of the quantum circuit is executed as part of the simulating, creating, after execution of that gate, a hash of a state vector that captures a state of the execution of the quantum circuit;
storing the hash, and respective associated data structure, in storage;
as part of a simulated execution process, calculating a hash of each gate across a new quantum circuit;
looking up, in the storage, a hash of a state vector associated with execution of one of the gates of the new quantum circuit; and
restoring, from storage, a latest hash of the state vector associated with the one gate of the new quantum circuit.

2. The method as recited in claim 1, wherein the simulated execution process comprises a resumption of the simulating of the execution of the quantum circuit.

3. The method as recited in claim 1, wherein the simulated execution process comprises simulating execution of a new quantum circuit that is different from the quantum circuit but has one or more states in common with the quantum circuit.

4. The method as recited in claim 1, wherein the restoring is performed for multiple gates and, for each gate, respective hashes are restored in reverse order.

5. The method as recited in claim 1, wherein the creating and storing are performed automatically during the simulating.

6. The method as recited in claim 1, wherein restoring the latest hash obviates a need to re-execute the gate, and recalculate a state vector, to which that latest hash pertains.

7. The method as recited in claim 1, wherein the hashes of the state vectors are created each time a gate is executed.

8. The method as recited in claim 1, wherein a gate of the quantum circuit comprises a custom gate which, when executed, triggers hashing of a state vector associated with the custom gate.

9. The method as recited in claim 1, wherein hashes are created for fewer than all of the gates of the quantum circuit.

10. The method as recited in claim 1, wherein when a gate execution does not affect the state, that state is not hashed.

11. A non-transitory storage medium having stored therein instructions that are executable by one or more hardware processors to perform operations comprising:
simulating execution of a quantum circuit on a classical computing infrastructure;
after one or more times that a gate of the quantum circuit is executed as part of the simulating, creating, after execution of that gate, a hash of a state vector that captures a state of the execution of the quantum circuit;
storing the hash, and respective associated data structure, in storage;
as part of a simulated execution process, calculating a hash of each gate across a new quantum circuit;
looking up, in the storage, a hash of a state vector associated with execution of one of the gates of the new quantum circuit; and
restoring, from storage, a latest hash of the state vector associated with the one gate of the new quantum circuit.

12. The non-transitory storage medium as recited in claim 11, wherein the simulated execution process comprises a resumption of the simulating of the execution of the quantum circuit.

13. The non-transitory storage medium as recited in claim 11, wherein the simulated execution process comprises simulating execution of a new quantum circuit that is different from the quantum circuit but has one or more states in common with the quantum circuit.

14. The non-transitory storage medium as recited in claim 11, wherein the restoring is performed for multiple gates and, for each gate, respective hashes are restored in reverse order.

15. The non-transitory storage medium as recited in claim 11, wherein the creating and storing are performed automatically during the simulating.

16. The non-transitory storage medium as recited in claim 11, wherein restoring the latest hash obviates a need to re-execute the gate, and recalculate a state vector, to which that latest hash pertains.

17. The non-transitory storage medium as recited in claim 11, wherein the hashes of the state vectors are created each time a gate is executed.

18. The non-transitory storage medium as recited in claim 11, wherein a gate of the quantum circuit comprises a custom gate which, when executed, triggers hashing of a state vector associated with the custom gate.

19. The non-transitory storage medium as recited in claim 11, wherein hashes are created for fewer than all of the gates of the quantum circuit.

20. The non-transitory storage medium as recited in claim 11, wherein when a gate execution does not affect the state, that state is not hashed.
